(19) United States
(12) Patent Application Publication
(10) Pub. No.: US 2008/0053842 A1
(43) Pub. Date: Mar. 6, 2008

(54) Conductivity cells and manufacturing methods

(76) Inventors: Arnold E. Williams, Boulder, CO (US); Donald Kenneth Forsberg, Johnstown, CO (US)

Correspondence Address: DINSMORE & SHOHL, LLP, 1900 CHEMED CENTER, 255 EAST FIFTH STREET, CINCINNATI, OH, 45202, US

(21) Appl. No.: 11/897,358

(22) Filed: Aug. 30, 2007

Related U.S. Application Data
(60) Provisional application No. 60/841,982, filed on Sep. 1, 2006.

(51) Int. Cl. G01N 27/26; B05D 3/00; G01N 27/30; G01N 27/40

(52) U.S. Cl. 205/775; 204/275.1; 204/415; 427/58

(57) ABSTRACT

A method of manufacturing a conductivity cell comprises providing two cell block halves, each cell block half having a trough with an electrode arranged in the trough, an inlet flow path leading to the trough, and an outlet flow path leading from the trough; covering the electrode with a curable adhesive and curing the adhesive; removing a portion of the cured adhesive to expose a portion of the electrode along the trough, wherein the exposed portion of the electrode is substantially continuous with the adjacent surfaces of the inlet flow path and the outlet flow path; and joining the two halves together with their respective troughs aligned to form a conductivity cell. A conductivity cell comprises two cell block halves, each cell block half having a trough with an electrode secured in the trough with a cured adhesive, an inlet flow path leading to the trough, and an outlet flow path leading from the trough, wherein a portion of the electrode along the trough is exposed and the exposed portion of the electrode is substantially continuous with the adjacent surfaces of the inlet flow path and the outlet flow path, and wherein the two halves are joined together with their respective troughs aligned.

### CROSS-REFERENCES TO RELATED APPLICATIONS

The present application claims the benefit under 35 U.S.C. § 119 of U.S. Application Ser. No. 60/841,982 filed Sep. 1, 2006.

### FIELD OF THE INVENTION

The present invention is directed to methods of manufacturing conductivity cells and is directed to conductivity cells. The invention is particularly directed to conductivity cells and methods which can be used to accurately measure minute quantities of an analyte in a solution.

### BACKGROUND OF THE INVENTION

The real time detection of minute quantities of an analyte in a solution is important in many different applications and is used, for example, in soil extract solutions, waste water, process water, manufacturing processes, and the like. One conventional method for measuring minute quantities of ammonia or ammonium cation involves combining the aqueous solution with caustic and contacting the solution with a membrane through which the analyte can pass, and detecting a conductivity change in a solution to which the analyte passes through the membrane using a conductivity cell. See, for example, the Hansen et al U.S. Pat. No. 6,090,267, incorporated herein by reference.

One problem which is typically encountered in measuring minute quantities of analyte according to such methods is interference from bubbles in the solution passing through the conductivity cell. Bubbles create a background noise level which makes accurate measurement of analyte difficult, particularly when low levels of analyte are to be measured. To avoid bubble interference, it is often customary to degas the analyte-containing solution prior to directing the solution to a conductivity cell. Such degassing can be effected by, for example, vacuum degassing or by contacting the solution with helium. Such degassing methods are time consuming and increase the cost of conducting the conductivity measurements and are of varied effectiveness depending on process conditions. Accordingly, it would be advantageous to avoid bubble interference when making such conductivity measurements.

### SUMMARY OF THE INVENTION

The present invention provides improved methods of manufacturing conductivity cells and provides improved conductivity cells and methods of using such cells.

In one embodiment, the invention is directed to a method of manufacturing a conductivity cell. The method comprises providing two cell block halves, each cell block half having a trough with an electrode arranged in the trough, an inlet flow path leading to the trough, and an outlet flow path leading from the trough; covering the electrode with a curable adhesive and curing the adhesive; removing a portion of the cured adhesive to expose a portion of the electrode along the trough, wherein the exposed portion of the electrode is substantially continuous with the adjacent surfaces of the inlet flow path and the outlet flow path; and joining the two halves together with their respective troughs aligned to form a conductivity cell.

In another embodiment, the invention is directed to a conductivity cell comprising two cell block halves, each cell block half having a trough with an electrode secured in the trough with a cured adhesive, an inlet flow path leading to the trough, and an outlet flow path leading from the trough, wherein a portion of the electrode along the trough is exposed and the exposed portion of the electrode is substantially continuous with the adjacent surfaces of the inlet flow path and the outlet flow path; and wherein the two halves are joined together with their respective troughs aligned.

The methods and conductivity cells according to the invention are advantageous for accurately measuring even minute amounts of an analyte in a sample stream, without any need to degas the stream prior to measurement, for example to eliminate gas bubbles which interfere with accurate measurements.

These and additional advantages and embodiments of the invention will be more evident in view of the following detail description.

### BRIEF DESCRIPTION OF THE DRAWINGS

The following detailed description will be more fully understood in view of the drawing in which:

FIG. 1 shows a schematic perspective view of a cell block half according to one embodiment of the method and conductivity cell of the invention;

FIG. 2 shows a perspective view of an electrode according to one embodiment of the method and conductivity cell of the invention;

FIG. 3 shows a top view of a cell block half having an electrode secured in the trough thereof, with a portion of the electrode along the trough exposed, according to one embodiment of the method and conductivity cell of the invention;

FIG. 4 shows an enlarged end view of the cell block half of FIG. 3;

FIG. 5 shows one embodiment of a conductivity cell according to the invention; and

FIG. 6 shows an embodiment of a diffusion membrane assembly in combination with a conductivity cell according to the invention.

The embodiments set forth in the drawing are illustrative in nature and are not intended to be limiting of the invention defined by the claims. Moreover, individual features of the drawing and the invention will be more fully apparent and understood in view of the detailed description.

### DETAILED DESCRIPTION

The present invention is directed to methods of manufacturing conductivity cells and provides improved conductivity cells and methods of using such cells. The cells may be employed in any environment where it is desirable to measure a change in conductivity.

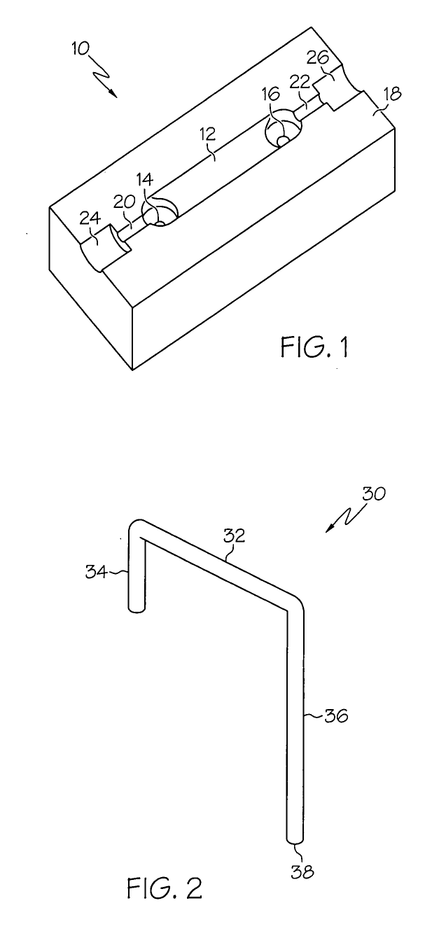

While many conventional conductivity cells are manufactured by drilling a flow path in a cell block and inserting electrodes into the resulting flow path, the present invention employs an assembled conductivity cell block formed form two cell block halves. FIG. 1 shows a schematic diagram of a cell block half suitable for use in the present invention. The cell block half 10 may be formed of any suitable material and, in one embodiment, is molded from a durable, corrosion resistant polymer material such as chlorinated polyvinyl chloride, polyvinylidene chloride, polyvinyl chloride (PVC), polyetheretherketone (PEEK), polyvinylidene fluoride (Kynar®), or the like. As will be apparent, it is preferred to employ a polymeric material which can be precisely molded and machined in order to obtain a conductivity cell of desired dimensions.

The cell block half 10 includes a trough 12 of a length and width sufficient to receive therein an electrode and a securing adhesive material. To accommodate electrode connections, in one embodiment, the trough includes one or more apertures 14, 16 extending from the trough to an outer surface of the cell block. In the embodiment of FIG. 1, at least one of the apertures 14, 16 extends to the surface opposite surface 18 to accommodate an electrode connection. FIG. 2 shows a schematic view of an electrode suitable for use in the conductivity cell block half 10 of FIG. 1. The electrode 30 includes a midsection 32 which is received in the trough 12 and extensions 34 and 36 which are received in apertures 14, 16, respectively. As will be appreciated, extension 36 is of a length sufficient to extend beyond the surface opposite surface 18 to provide an electrode connection at 38. The electrodes may be formed of any desired metal and one of ordinary skill will be able to select such based on the specific application of the conductivity cell. In specific embodiments, the electrodes comprise gold electrodes, silver electrodes, titanium electrodes, alloy electrodes formed of nickel silver (Cu—Ni—Zn), stainless steel, or the like.

The electrode 30 is arranged in the trough 12 and is secured therein by covering the electrode with a curable adhesive and curing the adhesive. Any suitable curable adhesive may be employed, as long as it does not contain leachable ions which would interfere with conductivity measurements. In a specific embodiment, an adhesive that cures to a hard material which is capable of precise machining is sued. One specific adhesive for use in the invention comprises epoxy adhesive. Urethane adhesives are also suitable for use in the methods and cells of the invention.

With reference to FIG. 1, the cell block half is provided with an inlet flow path 20 leading to the trough, and an outlet flow path 22 leading from the trough. In the embodiment shown, the cell block half further includes an inlet tubing receptacle 24 and an outlet tubing receptacle 26, each of which is adapted to accommodate the end of the respective tubing to supply a flowing stream to and from the conductivity cell. In a specific embodiment, the inlet tubing receptacle and the outlet tubing receptacle are configured to such that the inner surfaces of the inlet tubing and the outlet tubing are substantially continuous with the adjacent surfaces of the inlet flow path and the outlet flow path, respectively, when received in the corresponding receptacles in the assembled conductivity cell. Within the context of the present disclosure, substantially continuous adjacent surfaces means that the surfaces are of the same height at their juncture so that they form a smooth surfaced flow path with no raised edges or corners in the flow path.

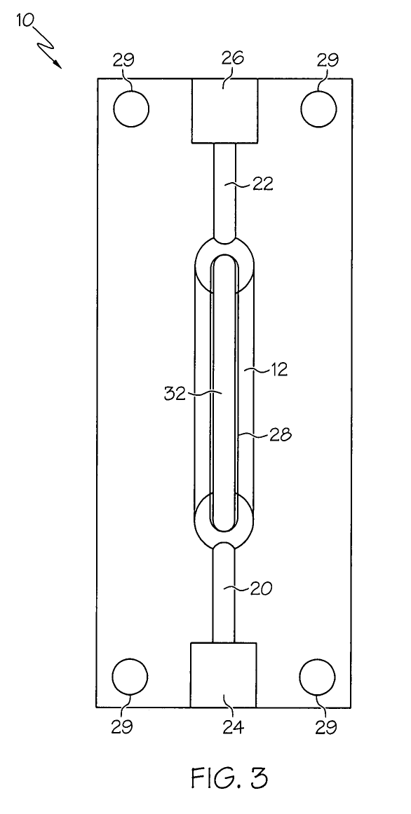

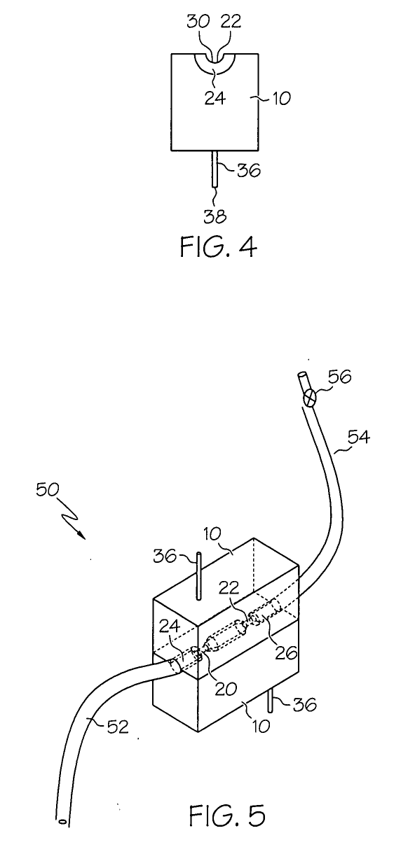

Once the adhesive covering and securing the electrode in the trough has cured, a portion of the cured adhesive is removed to expose a portion of the electrode along the trough. Importantly, the exposed portion of the electrode is substantially continuous with the adjacent surfaces of the inlet flow path and the outlet flow path. In accordance with the definition of “substantially continuous” set forth above, the adjacent surfaces of the exposed portion of the electrode and the inlet flow path and the adjacent surfaces of the exposed portion of the electrode and the outlet flow path are of the same height at their juncture so that they form a smooth surfaced flow path with no raised edges or corners in the flow path. It will be appreciated that portions of the electrode and/or the trough may be removed as well to obtain the substantially continuous arrangement. The electrode, trough and/or cured adhesive may be dimensioned such that a portion of the electrode itself is removed to provide the exposed portion of the electrode. In a specific embodiment, the cured adhesive, and optionally electrode surface, may be removed by machining such as milling to obtain the desired substantially continuous surfaces. One of ordinary skill in the art will also appreciate that removal of the cured adhesive, and electrode, as desired, will allow precise control of the space between opposed electrodes once two cell block halves are joined together to form the conductivity cell. Thus, machining such as milling can be used to define the flow path and the electrode gap. FIGS. 3 and 4 show top and end views of the cell block half 10 having the electrode 30 secured in the trough 12 thereof by the cured adhesive, with a portion of the electrode along the trough exposed, as described. As is apparent form the views of FIGS. 3 and 4, the inlet flow path 20, the exposed portion of the electrode 30, the remaining cured adhesive 28, and the outlet flow path 22 are substantially continuous.

Two cell block halves thus produced are then joined together with their respective troughs aligned to form a conductivity cell. The cell block halves may be joined by any means suitable in the art. In one embodiment, the cell block halves are joined with an adhesive or cement, for example, a polyvinyl chloride solvent cement to provide a fluid tight seal between the cell block halves. Alternatively, adhesive may be employed, for example epoxy or urethane adhesives. Mechanical clamping may also be employed, as long as fluid tight sealing is achieved. Each face 18 of the cell block halves may be provided with either guide pins or guide pin receiving apertures to assist in assembling the two cell block halves in proper alignment. For example, one cell block half is provided with guide pins at the respective corner areas while the other cell block half is provided with corresponding guide pin receiving apertures to receive the guide pins when the two cell block halves are joined together. The cell block 10 of FIGS. 3 and 4 includes guide pin receiving apertures 29.

FIG. 5 shows an assembled conductivity cell 50 formed of two cell block halves 10 as described. In one embodiment, the electrodes are dimensioned to provide a spacing area of 0.05-0.3 cm². The cell as described herein provides precise and rigid electrode positioning. With the assembled cell blocks, cell constants in 0.2-2.0 range may be obtained. As is known in the art, two electrodes of one square centimeter spaced one centimeter apart provide a cell constant of 1.0. The cell constant is proportional to the electrode area and inversely proportional to the spacing between the electrodes. For example, if the electrode areas were 0.1 cm² and the spacing was 0.1 cm, the cell constant would be 1.0. Typical ion chromatography cells have cell constants ranging from 1-10, as exemplified by the Dionix 1.0 and Alltech 10+ commercial products. The other variable of importance is cell volume, which affects response time. Both the Dionix and Alltech products have volumes of 1-2 microliters. In the conventional cells, constants in the range of 2-5 were commonly used. Now, with a typical cell constant of 0.4 in the cells of the present invention, the usable sensitivity of the system has been enhanced by a substantial amount (1.5-2 times). In one embodiment, a cell with a volume of 5 μl and a cell constant as low as 0.5 can be provided.

The conductivity cells of the invention have a straight through flow path containing no bends or edges to trap bubbles. Accordingly, the elaborate degassing procedures which have been conventionally employed, for example, to achieve stable performance of ammonia analyzers may be omitted and a conductivity cell as described herein may easily be operated to accurately measure quantities as low as 10 ppb of ammonia on a routine basis. A method for conducting a conductivity measurement of a flowing stream using the described conductivity cell therefore comprises directing the stream through the conductivity cell of as described and measuring a conductivity of the stream, in the absence of any degassing of the flow stream. The cell is suitable for operation at 1-10 psig, although other pressures may be employed as desired.

In the illustrated embodiment of FIG. 5, inlet tubing 52 and outlet tubing 54 are connected with the inlet flow path 20 and the outlet flow path 22, respectively, at the receptacles 24 and 26. Further, as described above, in one embodiment, the inner surfaces of the inlet tubing 52 and the outlet tubing 54 are substantially continuous with the adjacent surfaces of the inlet flow paths 20 and the outlet flow paths 22, respectively. Various tubings may be employed for connection to the conductivity cell of the invention. In one embodiment, the inlet and outlet tubings comprise PVC, for example, attached via solvent welding. Other tubing materials such as stainless steel, PEEK, and the like may be used and attached, for example, using epoxy or urethane adhesive.

In yet another embodiment, the conductivity cell further comprises a back pressure valve 56 downstream of the outlet flow path. The back pressure valve can improve high sensitivity of the conductivity cell and/or increase the signal to noise ratio. Suitably, the back pressure valve can be set at about 6 psig for a flow of 1-3 cm³/min.

Although any suitable dimensions may be employed in the conductivity cells of the invention, in one embodiment, the length of electrode arranged in the trough is approximately 0.25-0.5 inches, the electrode is exposed with a gap of about 0.015 inches from the surface 18 of the cell block half, whereby electrodes in respective troughs of two assembled cell block halves will be spaced about 0.03 inches from one another. In another specific embodiment, the inlet and outlet tubings have an inside diameter of about 1.1 millimeter. With the two piece assembly technique of the invention, it is possible, in a specific embodiment, to construct a cell with an internal volume of 15-20 microliters and a cell constant of 0.1-0.3 and yet maintain a straight through flow pattern. A straight through flow pattern, with no bends or edges to catch or retain bubbles, is a substantial improvement over alternate designs. While bubbles and dissolved gases have been perennial problems in sensing small changes in conductivity in aqueous solutions, the present invention, in short, is largely immune to bubble entrapment and resulting interference.

The combination of a low cell constant, for example less than about 0.5, and low holdup volume, for example less than about 50 microliters, is especially useful in flow injection analysis. The practical effect is to produce a high signal/noise ratio and thus very low detection limits of, for example, 1-2 ppb.

The conductivity cell according to the present invention may be used for measurement of various analytes in a sample. In one embodiment, the conductivity cell is used to measure ammonia, for example in an aqueous solution. The Timberline Ammonia Analyzer is a flow injection application in which the present invention may be employed. The conductivity cell can also be used to measure the concentrations of various volatile acids such as HCl, HNO₃, SO₂, formic acid, acetic acid, or the like, for example in aqueous solutions. Further, the conductivity cell according to the present invention can be used to measure acids in other types of solutions, including, but not limited to, nitric acid and sulfuric acid, sulfur dioxide and corn syrup, volatile acids, for example acetic acid, in wine, and the like.

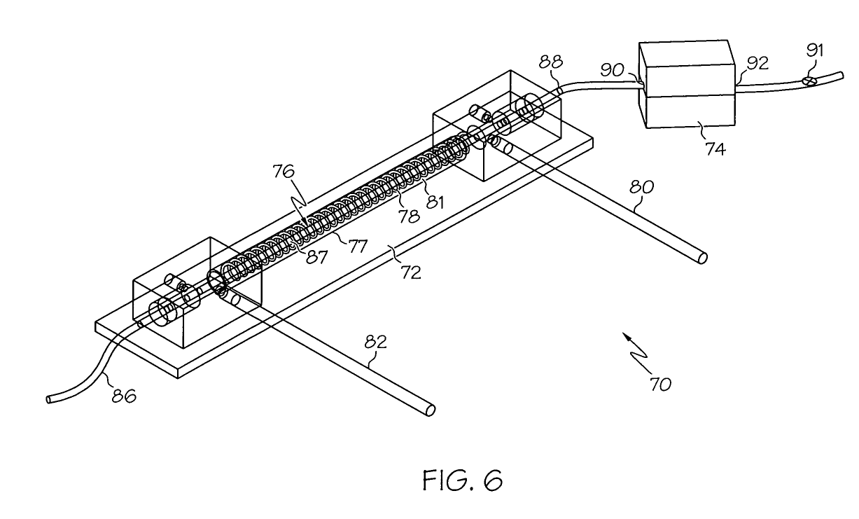

In one embodiment, the conductivity cell as described herein is used in combination with a diffusion membrane assembly in order to provide a system for detecting an analyte in a solution. Such a system is shown schematically in FIG. 6. With reference to FIG. 6, the system 70 for measuring an analyte in a solution comprises a diffusion membrane assembly 72 in combination with a conductivity cell 74 according to the present invention and as described above. The diffusion membrane assembly 72 includes an analyte-permeable membrane 76 which separates a first flow path having an inlet 80, a path 81, and an outlet 82, and a second flow path having an inlet 86, a path 87 and an outlet 88. Outlet 88 leads to an inlet flow path 90 of the conductivity cell. In a specific embodiment as shown in FIG. 6, the analyte-permeable membrane 76 is in the form of tubing and the first sample liquid flow path 81 flows outside the membrane tubing 76 while the second absorbent liquid flow path 87 flows inside the membrane tubing 76. As a result, an analyte will pass through the membrane from a sample liquid flowing through the first sample liquid flow path to an absorber liquid flowing in the second absorbent liquid flow path, and thereafter exiting the diffuser membrane assembly in the outlet 88 where it is directed to the conductivity cell 74 for measurement of the analyte therein. The conductivity cell may, as described above, include back pressure valve 91 downstream of the conductivity cell outlet flow path 92.

In one embodiment, the analyte-permeable membrane comprises polytetrafluroetylene tubing. In other embodiments, the analyte-permeable membrane may comprise polyvinylidene fluoride, polypropylene, polyethylene, or any other material suitable for allowing permeation of the desired analyte.

In one embodiment, as shown in FIG. 6, the membrane tubing 76 is positioned within a rigid tube 77 and centered and held therein with a spiral wire insert 78. The wire insert 78 provides consistent contact of the sample solution and the absorber solution and air entrainment with the membrane by directing fluid flow around the membrane in a continuous fashion. This reduces intermediate holdup resulting in a smoother baseline, thus providing lower detection limits.

In a specific embodiment, the system as described and shown schematically in FIG. 6 may be used to measure the content of ammonia in a sample liquid. Optionally, sodium hydroxide is mixed with the sample liquid to adjust the pH, for example to 12 or more, and the sample liquid is provided to the diffusion membrane assembly via inlet 80 along flow path 81. Simultaneously, an absorber solution, for example comprising a dilute buffer, is provided to flow path 87 via inlet 86. In one embodiment, the absorber solution comprises a dilute borate buffer, typically containing 50-500 ppm borate. Ammonia migrates through the membrane tubing 76 to the absorber solution and exits the diffusion membrane assembly via outlet 88 of the absorber solution flow path where it is directed to the conductivity cell 74. The conductivity cell measures changes in the conductivity of the buffer, allowing measurement of ammonia concentrations of from about 2 ppb to 20,000 ppm. In one embodiment, the system is suitable for measuring ammonia concentrations of from about 2 ppb to about 20 ppb. In other embodiments, ammonia concentrations of 50-100 ppb, or 500 ppb-150 ppm, may be measured.

Although the present system is described in connection with the measurement of ammonia, one of ordinary skill in the art will appreciate that the system may be used for measuring the concentration of various analytes other than ammonia in sample solutions.

The combination of a diffusion membrane assembly and a conductivity cell as described, preferably including a back pressure valve downstream of the conductivity cell flow outlet provides excellent performance without degassing of a solution prior to entering the conductivity cell. In fact, entrainment air may be furnished to achieve sharp peaks, allowing the system to detect less than 10 ppb, and excellent precision over very wide ranges, for example 10 ppb-10,000 ppm, without degassing or other steps to avoid interfering bubbles in fluid flow through the conductivity cell. Similarly, it may periodically be desirable to change or replenish a solution going through the conductivity cell and when this is done, a bubble of air is generally introduced into the flow going to the cell. In the present conductivity cell, the bubble passes through with little or no possibility of retention or interference.

The specific illustrations and embodiments described herein are exemplary only in nature and are not intended to be limiting of the invention defined by the claims. Further embodiments and examples will be apparent to one of ordinary skill in the art in view of this specification and are within the scope of the claimed invention.

What is claimed is:

1. A method of manufacturing a conductivity cell, comprising:
providing two cell block halves, each cell block half having a trough with an electrode arranged in the trough, an inlet flow path leading to the trough, and an outlet flow path leading from the trough;
covering the electrode with a curable adhesive and curing the adhesive;
removing a portion of the cured adhesive to expose a portion of the electrode along the trough, wherein the exposed portion of the electrode is substantially continuous with the adjacent surfaces of the inlet flow path and the outlet flow path; and
joining the two cell block halves together with their respective troughs aligned to form a conductivity cell.

2. The method of claim 1, wherein the cell block halves are formed of chlorinated polyvinyl chloride.

3. The method of claim 1, wherein each cell block half is provided with an aperture extending from the trough to an outer surface of the cell block half to accommodate an electrode connection.

4. The method of claim 1, wherein the curable adhesive comprises an epoxy resin.

5. The method of claim 1, wherein the electrodes comprise gold electrodes.

6. The method of claim 1, wherein the portion of the cured adhesive is removed by milling to expose a portion of the electrode along the trough.

7. The method of claim 6, wherein a portion of the electrode is removed in the milling process.

8. The method of claim 1, wherein the two halves are joined with a polyvinyl chloride solvent cement.

9. The method of claim 1, further comprising connecting inlet tubing and outlet tubing with the inlet flow path and the outlet flow path, respectively, wherein the inner surfaces of the inlet tubing and the outlet tubing are substantially continuous with the adjacent surfaces of the inlet flow path and the outlet flow path, respectively.

10. A conductivity cell, comprising two cell block halves, each cell block half having a trough with an electrode secured in the trough with a cured adhesive, an inlet flow path leading to the trough, and an outlet flow path leading from the trough, wherein a portion of the electrode along the trough is exposed and the exposed portion of the electrode is substantially continuous with the adjacent surfaces of the inlet flow path and the outlet flow path, and wherein the two halves are joined together with their respective troughs aligned.

11. The conductivity cell of claim 10, wherein the cell block halves are formed of chlorinated polyvinyl chloride.

12. The conductivity cell of claim 10, wherein each cell block half is provided with an aperture extending from the trough to an outer surface of the cell block half to accommodate an electrode connection.

13. The conductivity cell of claim 10, wherein the cured adhesive comprises a cured epoxy resin.

14. The conductivity cell of claim 10, wherein the electrodes comprise gold, silver, titanium, nickel silver (Cu—Ni—Zn), or stainless steel.

15. The conductivity cell of claim 10, wherein the two halves are joined with a polyvinyl chloride solvent cement.

16. The conductivity cell of claim 10, further comprising inlet tubing and outlet tubing connected with the inlet flow path and the outlet flow path, respectively, wherein the inner surfaces of the inlet tubing and the outlet tubing are substantially continuous with the adjacent surfaces of the inlet flow path and the outlet flow path, respectively.

17. The conductivity cell of claim 16, wherein the inlet tubing and the outlet tubing comprise PVC tubing.

18. The conductivity cell of claim 10, further comprising a back pressure valve downstream of the outlet flow path.

19. A method for conducting a conductivity measurement of a flowing stream, comprising directing the stream through the conductivity cell of claim 10 and measuring a conductivity of the stream, in the absence of any degassing of the flow stream.

20. A system for measuring an analyte in a solution, comprising
a diffusion membrane assembly including an analyte-permeable membrane separating a first sample liquid flow path and a second absorber liquid flow path, the analyte permeable membrane allowing an analyte to pass therethrough while preventing an aqueous liquid from passing therethrough; and
the conductivity cell of claim 10 in fluid flow communication with an outlet of the second absorber liquid flow path, downstream of the diffusion membrane assembly.

21. The system of claim 20, wherein the membrane comprises polytetrafluoroethylene and is ammonia permeable.

22. The system of claim 21, wherein the conductivity cell comprises a back pressure valve downstream of the outlet flow path.
